(19) United States
(12) Patent Application Publication
(10) Pub. No.: US 2011/0170403 A1
(43) Pub. Date: Jul. 14, 2011

(54) Service Movement in Link State Controlled Layer Two Networks

(75) Inventors: Peter Ashwood-Smith, Gatineau (CA); Yin Guoli, Ottawa (CA)

(73) Assignee: FUTUREWEI TECHNOLOGIES, INC., Plano, TX (US)

(21) Appl. No.: 12/985,731

(22) Filed: Jan. 6, 2011

Related U.S. Application Data
(60) Provisional application No. 61/293,565, filed on Jan. 8, 2010.

(51) Int. Cl. H04L 12/26; H04L 12/56

(52) U.S. Cl. 370/216; 370/392

(57) ABSTRACT

An apparatus comprising a first edge node configured to populate a learned table using a first frame received from a remote node via a second edge node, wherein the learned table comprises a remote node address and a first forwarding address associated with the remote node address, and wherein the first forwarding address is for the second edge node, receive a second frame destined for the remote node, and determine that the second frame should be sent to the second edge node using the learned table, wherein the first edge node is further configured to replace the first forwarding address in the learned table with a second forwarding address when the second edge node fails, and wherein the second forwarding address is for a third edge node.

### CROSS-REFERENCE TO RELATED APPLICATIONS

The present application claims the benefit of U.S. Provisional Patent Application No. 61/293,565, filed Jan. 8, 2010 by Peter Ashwood-Smith et al., and entitled “Service Prioritization in Link State Controlled Layer 2 Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Modern communications and data networks are comprised of nodes that transport data through the network. The nodes may include routers, switches, bridges, or combinations thereof that transport the individual data packets or frames through the network. Some networks may offer data services that forward data frames from one node to another node across the network without using pre-configured routes on the intermediate nodes. Other networks may forward the data frames from one node to another node across the network along pre-configured or pre-established paths. In some networks, the nodes may create Ethernet-Local Area Network (E-LAN) services, where traffic that corresponds to different services may be transported along different sub-networks, e.g. by different subsets of nodes. For example, the E-LAN services may comprise Institute of Electrical and Electronics Engineers (IEEE) 802.1aq network services, Virtual Private LAN Services (VPLS), or virtual local area network (VLAN) isolated services in the Internet Engineering Task Force (IETF) Transparent Interconnection of Lots of Links (TRILL).

### SUMMARY

In one embodiment, the disclosure includes an apparatus comprising a first edge node configured to populate a learned table using a first frame received from a remote node via a second edge node, wherein the learned table comprises a remote node address and a first forwarding address associated with the remote node address, and wherein the first forwarding address is for the second edge node, receive a second frame destined for the remote node, and determine that the second frame should be sent to the second edge node using the learned table, wherein the first edge node is further configured to replace the first forwarding address in the learned table with a second forwarding address when the second edge node fails, and wherein the second forwarding address is for a third edge node.

In another embodiment, the disclosure includes a network component comprising a receiver configured to receive a failure indication for an edge node that is coupled to a destination node, a circuit configured to replace a first address for the edge node in each entry in an address learned table with a second address for a backup edge node that is associated with the first address without acquiring the second address from a data frame sent form the backup edge node, and a transmitter configured to transmit to the backup edge node an incoming frame that comprises a destination address associated with the second address that replaces the first address in an entry in the address learned table.

In a third embodiment, the disclosure includes a method comprising receiving a message that indicates a node's failure, determining whether the failed node's address is in a learned table, replacing the node's address in each entry in the learned table with an address of a backup node that is associated with the failed node's address and obtained without address learning, and forwarding an incoming frame according to the updated learned table entries.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a link state based network.

FIG. 2 is a schematic diagram of another embodiment of a link state based network.

FIG. 3 is a schematic diagram of another embodiment of a link state based network.

FIG. 4 is a flowchart of an embodiment of an address association recovery method.

FIG. 5 is a schematic diagram of an embodiment of a transmitter/receiver unit.

FIG. 6 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any quantity of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for redirecting a connection with a first node from a second node to a third node, which may be end points or edge nodes in a network. The connection between the first node and the second node may be used to forward at least one frame from the first node via the second node to a destination node coupled to the second node and the third node. The connection between the first node and the second node may be established by associating the destination node's address with the second node's address, which may be obtained via a network learning mechanism. Specifically, the destination node's address and the second node's address may be maintained in a learned table entry at the first node. If the second node fails, the second node's address may be replaced by the third node's address in the learned table entry for the destination node's address. As such, the connection may be redirected to forward a frame from the first node to the destination node via the third node instead of the second node. The connection between the first node and the third node may be established by associating the destination node's address with the third node's address in the same learned table entry without relearning the third node's address. The third node's address may be known to the first node and associated with the second node's address before the second node fails, or may be unknown to the first node and subsequently given to the first node when the second node fails.

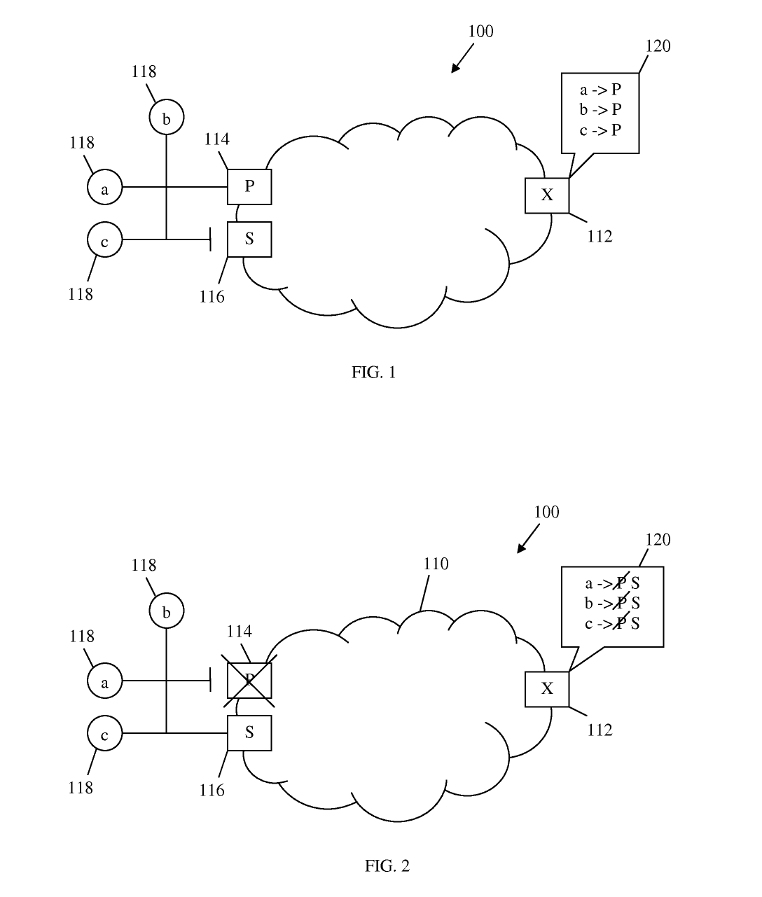

FIG. 1 illustrates one embodiment of a link state based network 100, for example where link states may be established using an Intermediate System-Intermediate System (IS-IS) protocol, an Open Shortest Path First (OSPF) protocol, or other network routing protocols. The link state based network 100 may comprise a plurality of nodes, which may comprise switches, routers, bridges, or combinations thereof. The nodes may comprise a first node 112, a second node 114, and a third node 116, which may be end points or edge nodes associated with an E-LAN service and may be coupled to each other via a plurality of links and/or other nodes (not shown) of the link state based network 100. The second node 114 and the third node 116 may be coupled to a plurality of destination nodes 118, which may be client or customer nodes outside the link state based network 100. The link state based network 100 may be any network that establishes link states or E-LAN services between the network nodes, such as an IEEE 802.1aq, VPLS networks, or VLAN isolated services in the IETF TRILL.

The E-LAN services may be a logical Open Systems Interconnection (OSI) Layer Two (layer 2) service. The Layer 2 services may be used to carry Layer 2 type data traffic that may have different priorities or importance to users and may be associated with a plurality of nodes. The E-LAN services may correspond to logical Ethernet point-to-point (ptp), point-to-multipoint (ptmp), or multipoint-to-multipoint (mptmp) sub-networks that may be established between the nodes to facilitate service traffic forwarding between the nodes. The E-LAN service may comprise a plurality of attachment points (e.g. nodes) that may be associated to by the same service identifier, such as a service instance identifier (I-SID). The E-LAN service may be used to forward service traffic between the nodes by binding the service to the service identifier. The link state based network 100 may establish other services similar to the E-LAN services, such as an Ethernet-Line (E-LINE) service for ptp communications and/or an Ethernet-Tree (E-TREE) service for ptmp communications.

The first node 112 may be configured to forward a plurality of incoming frames to one or more destination nodes 118 of the frames via the second node 114. The first node 112 may receive the frames from one or more external nodes or networks (not shown) and forward the frames to the second node 114, for instance via the E-LAN service in the link state based network 100. To forward the frames properly to the corresponding destination nodes 118, the first node 112 may associate the destination node's addresses (e.g. a, b, and c) with the second node's address or a label that indicates the second node 114 (e.g. P). For example, the first node 112 may associate the destination node's Media Access Control (MAC) address with the second node's MAC address. The addresses or labels of the first node 112, the second node 114, and the third node 116 are indicated by X, P, and S, respectively.

The second node's address or label may be associated with each destination node address in an entry in a learned table 120, which may be maintained at the first node 112. For example, the learned table 120 may comprise three entries associated with the three destination node 118 that are coupled to and receive frame from the first node 112 via the second node 114. The first node 112 may forward each incoming frame that comprises the destination address a, b, or c to the second node 114 indicated by the second node's address in the corresponding learned table entries. The second node 114 may in turn forward the frame to the corresponding destination node 118, e.g. based on the destination address in the frame and the entries in the learned table 120.

The first node 112 may associate the destination node's addresses with the second node's address or label in an entry in the learned table 120 after learning the second node's address according to an address learning mechanism, such as used in Ethernet based networks. The Ethernet address learning mechanism may comprise flooding or multicasting a frame received at the first node 112 into the link state based network 100 when the frame's destination address is unknown. In addition, the first node 112 may receive another frame from the second node 114, where the other frame comprises a source address associated with one of the destination node 118 that originated the frame or at least part of the frame payload. Thus, the first node 112 may associate the source address in the frame with the second node's address and thereby learn the relationship between the second node 114 and the destination node 118.

The learned table 120 may be any table that associates destination addresses with intermediate forwarding addresses and that is populated by reading the source addresses from frames that originated from a remote node having the destination address. For example, in a IEEE 802.1aq network, the first node 112 may learn the second node's address that is associated with a destination node's address Ethernet MAC-in-MAC learning, e.g. according to the IEEE 802.1ah standard. In such a case, the learned table 120 may be a filtering database (as defined in section 8.6 of IEEE 802.1aq) or a Customer-MAC (C-MAC) to Backbone-MAC (B-MAC) table. In the case of a VPLS network, the second node's address may be associated with the destination node's address via L2 Virtual Private Network (L2VPN) service learning. In such a case, the learned table 120 may be a forwarding information base (FIB) (as defined in section 7.2 of IETF Request for Comments (RFC) 4762) or a C-MAC to multi-protocol label switching (MPLS) label table. Alternatively, in a TRILL network, the second node's address may be associated with the destination node's address via Customer-MAC (C-MAC) to destination node address learning. In such a case, the learned table 120 may be an RBridge's database of MAC addresses and VLANs (as defined in section 4.6.1.1 of IETF document draft-ietf-trill-rbridge-protocol-16) or a C-MAC to TRILL header table.

The third node 116 may be configured as a back up end point to the second node 114 to provide redundancy or fault recovery in the case of a failure in the second node 114. The third node 116 may be coupled to at least some of the same destination nodes 118 as the second node 114 and may be used to forward frames from the first node 112 to the destination nodes 118 if the second node 114 fails. Although the third node 116 may be physically coupled (via functioning links) to the destination nodes 118, the connection between the third node 116 and the destination nodes 118 may not be used when the second node 114 is functioning properly and forwarding the frames from the first node 112 to the destination nodes 118 via the second node 114. This scenario is indicated in FIG. 1 by showing a connected path between the second node 114 and the destination nodes 118 and a disconnected path between the third node 116 and the destination nodes 118. The third node 116 may be associated with the same service identifier as the second node 114 and the first node 112, and thus the three nodes may exchange traffic via the same E-LAN service. When the second node 114 fails, the first node 112 may reconnect to the third node 116 instead of the second node 114 to continue forwarding frames to the destination nodes 118 via the third node 116.

Typically, an address learning mechanism may be implemented to associate the destination node's addresses (e.g. MAC addresses) with the third node's address (e.g. MAC address) or label at the first node 114, and thus establish a new connection from the first node 112 to the third node 116. The association between the third node's address and a destination node's address may be added in a new entry in the learned table 120. For example, this scenario may be used in current 802.1aq networks. Relearning the third node's address for each destination node's address may be time consuming, affect recovery time, and/or increase network operational cost. Alternatively, the destination node's address may be associated with the third node's address instead of the second node's address by “moving” the third node's address. Moving the third node's address may require reconfiguring the routing tables in the network in the case of a failure in the second node 114 and may have similar or different disadvantages as the relearning method.

Instead, the first node 112 may have knowledge of the association between the third node's address and the second node's address prior to a failure in the second node 114. For example, the first node 112 may be informed of the association between the second node 114 and its backup third node 116 and may be provided with the third node's address before the second node 114 fails. Alternatively, an entity in the link state based network 100, such as the control plane, may have knowledge of the association between the second node 114 and the third node 116 and may provide the first node 112 with the third node's address upon a failure in the second node 114. Thus, the first node 112 may replace the second node's address in each entry in the learned table 120 with the third node's address without implementing an address learning mechanism or moving the addresses of the associated nodes. Associating the third node's address with the second node's address at the first node 112 prior to a failure in the second node 114 may allow the first node 112 to reconnect from the second node 114 to the third node 116 by reconfiguring the corresponding learned table entries. This method may allow faster recovery time, may be less difficult to implement, and/or may have lower network cost in comparison to the address learning and address moving schemes.

FIG. 2 illustrates another embodiment of the link state based network 100, where the second node 114 may fail, and thus may not be capable of forwarding the frames from the first node 112 to the corresponding destination nodes 118. In this case, the first node 112 may be informed by the failure of the second node 114, and thus may associate the destination nodes' addresses in the corresponding learned table 120 entries with the third node's address. The first node 112 may replace the second node's address, P, in each entry of the learned table 120 with the third node's address, S. Hence, the first node 112 may begin to forward the incoming frames, which may be destined to the destination nodes 118, to the third node 116 instead of the failed second node 114. The third node 116 may in turn forward the frames to the corresponding destination nodes 118, e.g. based on the destination addresses in the frames. This scenario is indicated in FIG. 2 by showing a connected path between the third node 116 and the destination nodes 118 and a disconnected path between the second node 114 and the destination nodes 118.

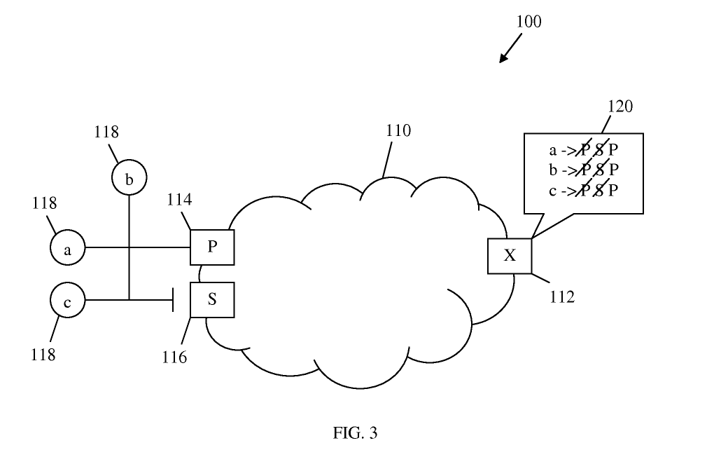

Additionally, the known association between the second node 114 and the third node 116 may allow the first node 112 to reconnect from the third node 116 to the second node 114 by reconfiguring the corresponding learned table entries when the second node 114 recovers and may restart forwarding the frames. The first node 112 may reconnect to the second node 114 since the third node 116 may be a backup node that may only be used when the second node 114 fails. FIG. 3 illustrates another embodiment of the link state based network 100, where the second node 114 may recover, and thus may become capable of forwarding the frames from the first node 112 to the corresponding destination nodes 118. In this case, the first node 112 may be informed of the recovery of the second node 114, and thus may associate the destination nodes' addresses in the corresponding learned table 120 entries with the second node's address. The first node 112 may replace the third node's address, S, in each entry of the learned table 120 with the second node's address, P. Hence, the first node 112 may return to forwarding the incoming frames, which may be destined to the destination nodes 118, to the recovered second node 114 instead of the backup third node 116. This scenario is indicated in FIG. 3 by showing a connected path between the second node 114 and the destination nodes 118 and a disconnected path between the third node 116 and the destination nodes 118.

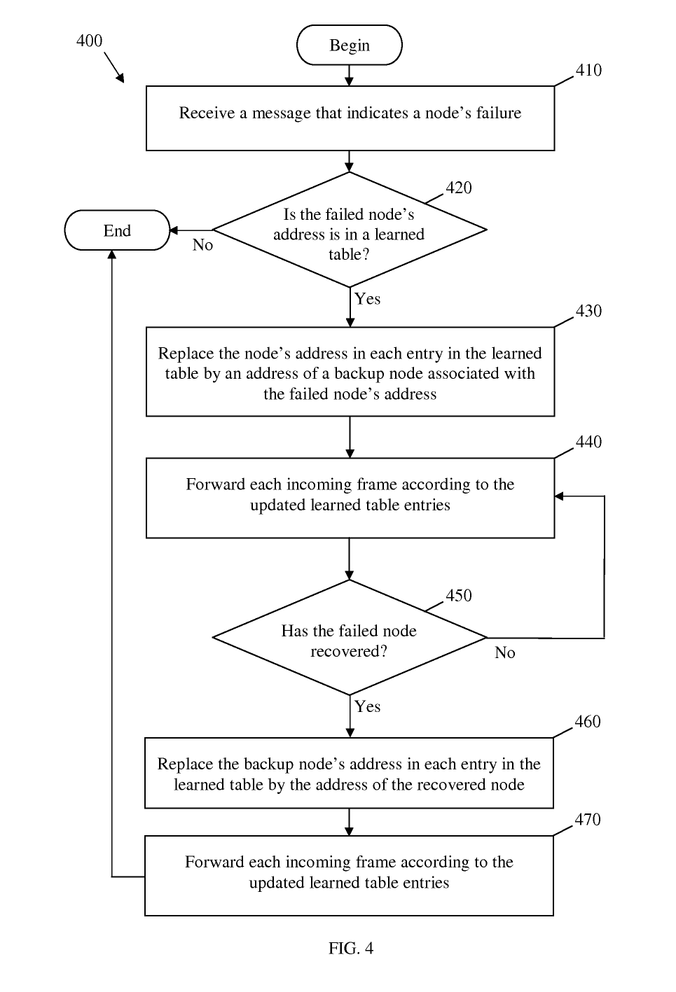

FIG. 4 illustrates an embodiment of address association recovery method 400, which may be implemented in a link state based network, such as the link state based network 100. The address association recovery method 400 may be implemented at an ingress node (e.g. the first node 112), which may be an end point that receives a plurality of frames that are intended to a plurality of destination nodes (e.g. the destination nodes 118). The method 400 may begin at block 410, where a message is received that indicates a node's failure. For instance, the first node 112 may receive a message indicating the failure of the second node 114. The message may be sent by the link state based network 100, a control plane, or a destination node 118 that was in communication with the second node 114. At block 420, the method 400 may determine whether the failed node's address is in a learned table. For instance, the first node 112 may search the entries of the learned table 120 for a match to the second node's address. If the node's address is in the learned table, then the method 400 may proceed to block 430. Otherwise, the method 400 may end.

At block 430, the node's address in each entry in the learned table may be replaced by an address of a backup node associated with the failed node's address. For instance, the first node 112 may replace the second nodes' address in each entry that corresponds to a destination node 118, e.g. that comprises the destination node's address, with the third node's address. The first node 110 may have prior knowledge of the association between the second node 114 and the third node 116 and their corresponding addresses. The association between the second node's address and the third node's address may be indicated to the first node 112 by the network, the control plane, or a destination node 118 prior to the failure of the second node 114. Alternatively, the association between the second node's address and the third node's address may be indicated to the first node 112 by the network, the control plane, or a destination node 118 upon the failure of the second node 114. At block 440, each incoming frame may be forwarded according to the updated learned table entries. Thus, the first node 112 may redirect each frame that is intended to a destination node 118 to the third node 116 instead of the second node 114. For instance, the first node 112 may receive the association between the second node's address and the third node's address, which may be indicated via signaling or messaging or may be preconfigured with that information by the network or the operator.

At block 450, the method 400 may determine whether the failed node has recovered. For instance, the first node 110 may receive an indication from the network that the second node 114 has recovered and may be capable again to forward frames to the destination nodes 118. If the condition in block 450 is met, then the method 400 may proceed to block 460. Otherwise, the method 400 may return to block 440. At block 460, the backup node's address in each entry in the learned table may be replaced by the address of the recovered node. For instance, the first node 112 may replace the third nodes' address in each entry that corresponds to a destination node 118 with the second node's address. At block 470, each incoming frame may be forwarded according to the updated learned table entries. Thus, the first node 112 may resume forwarding each frame that is intended to a destination node 118 to the second node 114. The method 400 then may end.

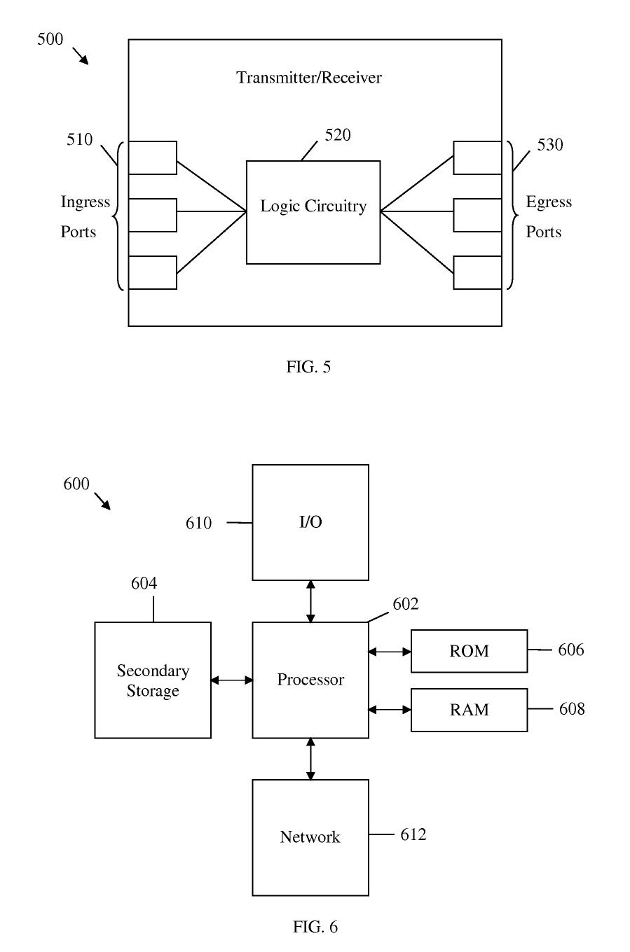

FIG. 5 illustrates an embodiment of a transmitter/receiver unit 500, which may be located at or coupled to any of the components described above, e.g. in the link state based network 100. The transmitter/receiver unit 500 may be any device that transports data through the network. For instance, the transmitter/receiver unit 500 may correspond to or may be located in any of the nodes 110. The transmitted/receiver unit 500 may comprise a plurality of ingress ports or units 510 for receiving frames, objects, or type-length-values (TLVs) from other nodes, logic circuitry 520 to determine which nodes to send the frames to, and a plurality of egress ports or units 530 for transmitting frames to the other nodes. The transmitter/receiver unit 500 also may comprise a buffer (not shown) between the ingress ports 510 and the logic circuit 520 and/or between the logic circuit 520 and the egress node 530.

The network components (e.g. the nodes 110) described above may be implemented on any general-purpose network component, such as a computer or network component with sufficient processing power, memory resources, and network throughput capability to handle the necessary workload placed upon it. FIG. 6 illustrates a typical, general-purpose network component 600 suitable for implementing one or more embodiments of the components disclosed herein. The network component 600 includes a processor 602 (which may be referred to as a central processing unit (CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips, or may be part of one or more application specific integrated circuits (ASICs) and/or digital signal processors (DSPs).

The secondary storage 604 is typically comprised of one or more disk drives or tape drives and is used for non-volatile storage of data and as an over-flow data storage device if RAM 608 is not large enough to hold all working data. Secondary storage 604 may be used to store programs that are loaded into RAM 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RAM 608 is used to store volatile data and perhaps to store instructions. Access to both ROM 606 and RAM 608 is typically faster than to secondary storage 604.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g. from about 1 to about 10 includes 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a first edge node configured to:
populate a learned table using a first frame received from a remote node via a second edge node, wherein the learned table comprises a remote node address and a first forwarding address associated with the remote node address, and wherein the first forwarding address is for the second edge node;
receive a second frame destined for the remote node; and
determine that the second frame should be sent to the second edge node using the learned table,
wherein the first edge node is further configured to replace the first forwarding address in the learned table with a second forwarding address when the second edge node fails, and wherein the second forwarding address is for a third edge node.

2. The apparatus of claim 1, wherein first edge node, the second edge node, and the third edge node are assigned a service identifier associated with an Ethernet-Local Area Network (E-LAN) service.

3. The apparatus of claim 2, wherein the Ethernet-Local Area Network (E-LAN) services are Institute of Electrical and Electronics Engineers (IEEE) 802.1aq based services at the Open Systems Interconnection (OSI) network Layer Two (layer 2) or Virtual Private Local Area Network (LAN) based services (VPLS).

4. The apparatus of claim 1, wherein the second edge node and the third edge node are both coupled to the remote node.

5. The apparatus of claim 4, wherein the third edge node only forwards traffic from the first edge node to the remote node when the second edge node fails.

6. The apparatus of claim 1, wherein the learned table is a filtering database as defined in section 8.6 of Institute of Electrical and Electronics Engineers (IEEE) 802.1aq.

7. The apparatus of claim 1, wherein the learned table is a forwarding information base (FIB) as defined in section 7.2 of the Internet Engineering Task force (IETF) Request for Comments (RFC) 4762.

8. The apparatus of claim 1, wherein the learned table is an RBridge's database of media access control (MAC) addresses and virtual local area networks (VLANs) as defined in section 4.6.1.1 of the Internet Engineering Task force (IETF) document draft-ietf-trill-rbridge-protocol-16.

9. The apparatus of claim 1, wherein the second forwarding address is replaced in the learned table without using an address learning mechanism.

10. A network component comprising:
a receiver configured to receive a failure indication for an edge node that is coupled to a destination node,
a circuit configured to replace a first address for the edge node in each entry in an address learned table with a second address for a backup edge node that is associated with the first address without acquiring the second address from a data frame sent form the backup edge node; and
a transmitter configured to transmit to the backup edge node an incoming frame that comprises a destination address associated with the second address that replaces the first address in an entry in the address learned table.

11. The network component of claim 10, wherein the second address is associated with the first address as part of network configuration and prior to receipt of the failure indication.

12. The network component of claim 10, wherein the second address is associated with the first address according to a message received prior to receipt of the failure indication.

13. The network component of claim 10, wherein the second address is associated with the first address according to information in the failure indication.

14. The network component of claim 10, wherein the destination address is associated with the second address only if the edge node fails, and wherein destination address is only associated with the first address when the edge node recovers.

15. The network component of claim 10, wherein the frame is forwarded to the backup edge node via an Ethernet-Local Area Network (E-LAN) service that is associated with both the edge node and the backup edge node.

16. The network component of claim 10, wherein the destination address is associated with the first address before the edge node fails via a network address learning scheme.

17. A method comprising:
receiving a message that indicates a node's failure;
determining whether the failed node's address is in a learned table;
replacing the node's address in each entry in the learned table with an address of a backup node that is associated with the failed node's address and obtained without address learning; and
forwarding an incoming frame according to the updated learned table entries.

18. The method of claim 17 further comprising:
replacing the backup node's address in each entry in the learned table by the address of the recovered node if the failed node has recovered; and
forwarding a second incoming frame according to the recovered node according to the updated learned table entries.

19. The method of claim 17, wherein the association between the backup node's address and the failed node address is received from a destination node that corresponds to a destination address in a learned table entry that comprises the failed node's address.

20. The method of claim 17, wherein the association between the backup node's address and the failed node address is received from a network control plane.
